(19) United States
(12) Patent Application Publication
(10) Pub. No.: US 2019/0283864 A1
(43) Pub. Date: Sep. 19, 2019

(54) COUNTER-ROTATING PROPELLER SYSTEM WITH CAPABILITY TO STOP ROTATION OF ONE ROW

(71) Applicant: Hamilton Sundstrand Corporation, Charlotte, NC (US)

(72) Inventor: Chad M. Henze, Granby, CT (US)

(21) Appl. No.: 15/924,030

(22) Filed: Mar. 16, 2018

(51) Int. Cl. B64C 11/30; B64C 11/48; B64D 35/04

(52) U.S. Cl. CPC B64C 11/308; B64D 2027/005; B64D 35/04; B64C 11/48

(57) ABSTRACT

A propeller system has a pair of rotors and a pair of blade sets and at least one a drive input to drive a first of the rotors and blade sets and a second of the rotors and blade sets. The blade sets are positioned such that when both are driven, air will be driven across the first blade set and then across the second blade set. There is a pitch change mechanism to change an angle of incidence of the blade in at least one blade sets. There is a device for selectively stopping rotation of at least one of the first or second rotor and blade set while still allowing rotation of the other rotor and blade set. The pitch change mechanism of the stopped blade set can still change the angle of incidence when the device has stopped rotation. A method is also disclosed.

### BACKGROUND

This application relates to counter-rotating propeller systems, such as for use on aircraft where one of the rows can be selectively stopped from rotating and its blades utilized as guide vanes during lower power operation.

Propeller systems are known and often utilized to provide propulsion to aircraft. One known type of propeller system has two co-axial sets of rotating blades rotating with separate hubs. In many cases, the two sets of blades rotate in opposite directions. These are called counter-rotating propeller systems.

It is also known to provide guide vanes either upstream or downstream of a propeller, which may have a variable angle of incidence, such as to redirect flow upstream or capture swirl downstream of the propeller blades. In at least one known system, there are dedicated guide vanes positioned downstream of the rotor and blades.

### SUMMARY

A propeller system has a pair of rotors and a pair of blade sets and at least one drive input to drive a first of the rotors and blade sets and a second of the rotors and blade sets. The blade sets are positioned such that when both are driven, air will be driven across the first blade set and then across the second blade set. There is a pitch change mechanism to change an angle of incidence of the blade in at least one of the first and second blade sets. There is a device for selectively stopping rotation of the at least one of the first or second rotor and blade set while still allowing rotation of the other rotor and blade set. The pitch change mechanism of the stopped blade set can still change the angle of incidence when the device has stopped rotation.

A method is also disclosed.

These and other features may be best understood from the following drawings and specification.

### BRIEF DESCRIPTION OF THE DRAWINGS

FIG. 1 schematically shows a propeller system.

FIG. 2 schematically shows a blade angle.

FIG. 3 schematically shows a first drive arrangement.

FIG. 4 schematically shows another alternative drive.

### DETAILED DESCRIPTION

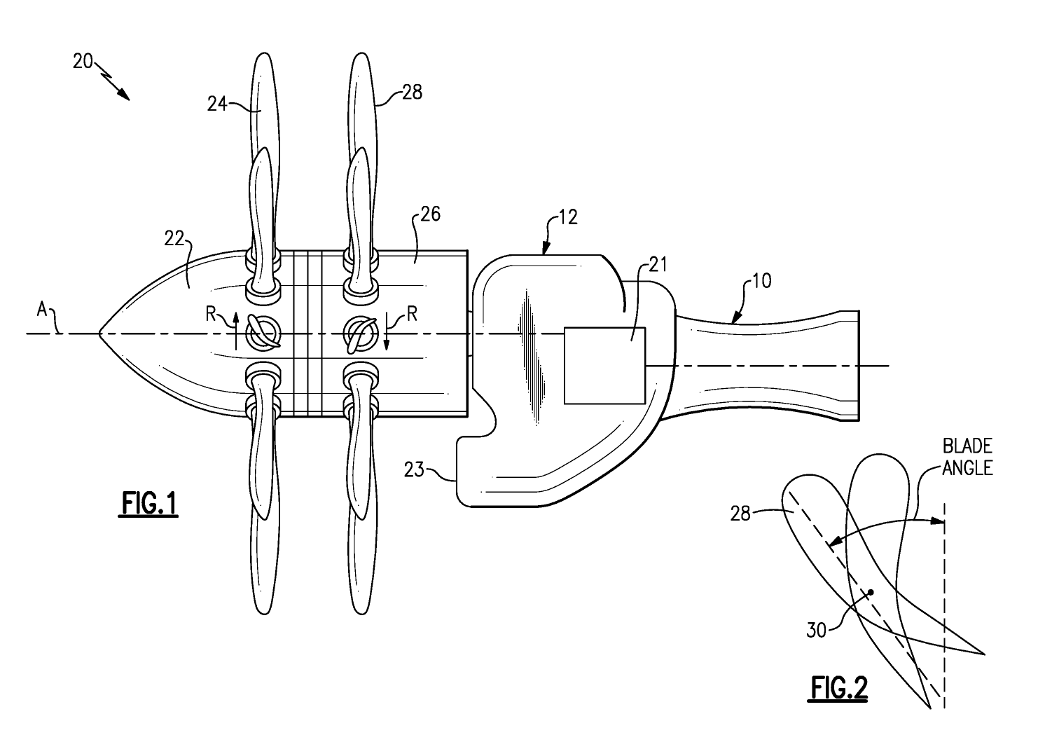

FIG. 1 shows a propeller system 20. An engine, such as a turbine engine 21, is illustrated schematically and drives hubs 22 and 26. An inlet 23 provides air to the turbine engine 21. Other drives could be utilized. A first set of blades 24 rotates in one direction with a forward hub portion 22. A second set of blades 28 rotates in the opposite direction with a hub portion 26.

Air is driven by blades 24 and then across blades 28 which drive additional air flow.

FIG. 2 schematically shows a feature of the blades 28 and, namely, that an angle of incidence or pitch angle of the blades can change about a pivot axis 30. In one embodiment, the same is true of the blades 24. In yet another embodiment blades 24 have a pitch change, but blades 28 do not.

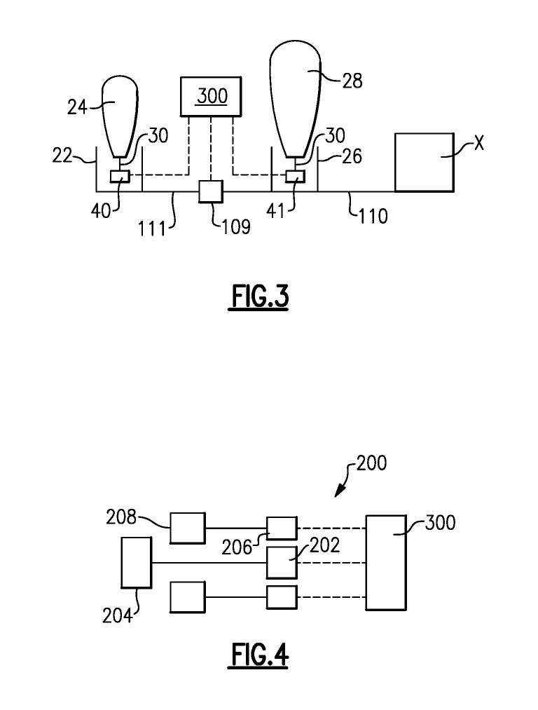

FIG. 3 shows further schematic details of one system. A pitch change mechanism 40 allows the blades 24 to pivot about the axis 30.

A pitch change mechanism 41 can change the pitch angle of the blades 28 about their respective axis 30.

Pitch change mechanisms are known, and mechanisms 40/41 may be known.

The pitch change of propeller systems in normal operation serves two functions. One is to allow for efficient conversion of power into thrust over a range of operating conditions including varying forward speeds by properly aligning the propeller blades with the incoming flow.

The second is to allow the propeller system to control its speed of rotation.

FIG. 3 shows a drive input X driving a shaft portion 110 to, in turn, drive a shaft portion 111 through a clutch 109.

The clutch 109 is shown as being controlled by a control 300. The control 300 further controls the pitch change mechanisms 40 and 41.

Now, at lower power operation, the control 300 may open the clutch 109 stopping rotation of the hub 22 and blades 24. The angle of the blades 24 can still be changed by pitch change mechanism 40, such that the now stopped blades 24 can provide the function of guide vanes, as described below. Thus, the guide vane function is provided without the requirement of having a separate guide vane row. The use of such guide vanes becomes particularly valuable at lower power operation, and when it is not necessary to have both blade sets 24 and 28 to provide sufficient propulsion. The lower power operation could be cruise of the associated aircraft, and the higher power operation could be take-off of the associated aircraft.

Allowing the stopped blade row to change pitch is intended to allow the blades to operate efficiently as guide vanes over a range of operating conditions including varying flight speeds. In the case where the guide vanes are aft of the rotating row, the vanes turn the swirling flow from the propeller in the axial direction converting some of the wasted energy in the swirling flow into thrust. Similarly, in the situation where the guide vanes are in front of the rotating blade row, the flow is swirled coming into the rotating row such that the flow exiting the rotating row is more predominantly in the axial direction, and thus generating more thrust, than it would have done without the guide vanes. A skilled worker in this art would recognize when a particular angle is desirable.

In another embodiment, a clutch could be positioned to stop the rotation of the hub 26 and blades 28 which would then serve as guide vanes for the flow exiting the rotating front blade set 24. FIG. 4 shows yet another embodiment, which is shown schematically. Here, embodiment 200 has a first drive 202 for driving one hub 204. A second separate drive 206 drives the second hub 208. Both drives 202 and 206 are controlled by control 300. In this embodiment, the control 300 may stop the drive 202 or 206, as appropriate, to stop rotation of the particular hub 204 or 208. This embodiment would operate as those described above.

As can be appreciated, any number of mechanisms can be employed to stop drive of one of the blade sets. Those disclosed here are examples.

Although embodiments have been disclosed, a worker of ordinary skill in this art would recognize that certain modifications would come within the scope of this disclosure. For that reason, the following claims should be studied to determine the true scope and content of this disclosure.

1. A propeller system comprising:
a pair of rotors and a pair of blade sets and at least one drive input to drive a first of said rotors and blade sets and a second of said rotors and blade sets;
said blade sets being positioned such that when both are driven, air will be driven across said first blade set, and then across said second blade set;
there being a pitch change mechanism to change an angle of incidence in at least one of said first and second blade sets, and there being a device for selectively stopping rotation of said at least one of said first and second blade sets while still allowing rotation of the other of said first and second blade sets; and
said pitch change mechanism of said at least one of said first and second blade sets still allowing change of said angle of incidence when said device has stopped rotation.

2. The propeller system as set forth in claim 1, wherein said at least one drive input is a single drive input.

3. The propeller system as set forth in claim 2, wherein said device is a clutch.

4. The propeller system as set forth in claim 1, wherein a control selectively changes the angle of incidence of said one of said first and second blade sets and also selectively controls said device.

5. The propeller system as set forth in claim 1, said control causing said one of said first and second blade sets to be driven when at higher power operation of an associated aircraft, and stopping rotation of said one of said first and second blade sets at lower power operation of said aircraft.

6. The propeller system as set forth in claim 5, wherein said higher power operation includes a take-off condition for the associated aircraft.

7. The propeller system as set forth in claim 6, wherein said lower power operation includes a cruise condition of the associated aircraft.

8. The propeller system as set forth in claim 1, wherein said device is a clutch for stopping rotation of said one of said first and second blade sets.

9. The propeller system as set forth in claim 1, wherein said at least one drive input to said first and second rotors and blade sets are two separate drive inputs, and said device is a control for stopping drive input from a respective one of said first and second drive inputs.

10. The propeller system as set forth in claim 9, wherein a control causes said one of said first and second blade sets to be driven at higher power operation of an associated aircraft, and stops rotation of said one of said first and second blade sets at lower power operation of said aircraft.

11. A method of operating a propeller system mounted on an aircraft comprising the steps of:
(a) providing a pair of rotors and a pair of blade sets and driving a first of said rotors and blade sets and a second of said rotors and blade sets; and
(b) stopping rotation of one of said first and second blade sets, while still rotating a second of said first and second blade sets, and changing an angle of incidence of said one of said first and second blade sets while it is stopped from rotating.

12. The propeller system as set forth in claim 11, wherein a control selectively changing the angle of incidence of one of said first and second blade sets and also selectively controlling a device to stop rotation of said at least one of said first and second blade sets.

13. The propeller system as set forth in claim 12, wherein said control causing said one of said first and second blade sets to be driven at higher power operation of an associated aircraft, and stopping rotation of said one of said first and second blade sets at lower power operations.

14. The propeller system as set forth in claim 13, wherein said higher power operation includes a take-off condition for the associated aircraft.

15. The propeller system as set forth in claim 14, wherein said lower power operation includes a cruise condition of the associated aircraft.

16. The propeller system as set forth in claim 11, wherein a control causing said one of said first and second blade sets to be driven at higher power operation of an associated aircraft, and stopping rotation of said one of said first and second blade sets at lower power operations.

17. The propeller system as set forth in claim 16, wherein said higher power operation includes a take-off condition for the associated aircraft.

18. The propeller system as set forth in claim 14, wherein said lower power operation includes a cruise condition of the associated aircraft.

19. The propeller system as set forth in claim 11, wherein a clutch is opened for stopping rotation of said one of said first and second blade sets.

20. The propeller system as set forth in claim 11, wherein said drive to said first and second rotors and blade sets is provided by two separate drive inputs, and a control stopping drive input from a respective one of said two drive inputs.
